(19) United States
(12) Patent Application Publication
(10) Pub. No.: US 2005/0085612 A1
(43) Pub. Date: Apr. 21, 2005

(54) Aminomethylene-functional siloxanes

(76) Inventors: Oliver Schafer, Burghausen (DE); Wolfram Schindler, Tubling (DE); Bernd Pachaly, Mehring-Od (DE); Andreas Bauer, Kirchdorf (AT)

Correspondence Address: BROOKS KUSHMAN P.C., 1000 TOWN CENTER, TWENTY-SECOND FLOOR, SOUTHFIELD, MI, 48075, US

(21) Appl. No.: 10/504,351

(22) PCT Filed: Jan. 23, 2003
(86) PCT No.: PCT/EP03/00701

(30) Foreign Application Priority Data
Feb. 14, 2002 (DE) 102 06 124.6

(51) Int. Cl. C08G 77/04; C08G 77/26

(52) U.S. Cl. 528/34; 528/38

(57) ABSTRACT

Primary aminoalkyl-terminated organopolysiloxanes are prepared simply and in high yield by reaction of hydroxyl-terminated organopolysiloxanes with an aminoalkyl-and alkoxy-functional silane. The primary aminoalkyl-terminated organopolysiloxanes are particularly useful as polymer intermediates in the preparation of polymers such as polyimides and polyureas.

The invention relates to aminomethylene-functional siloxanes and to a process for preparing them using alkoxysilanes.

Aminoalkylpolysiloxanes can be used in many fields of application, including the preparation of polyimides and polyetherimides. However, the commercial use of these compounds on a relatively large scale is prevented by a relatively expensive preparation process.

For example, the base-catalysed equilibration of octamethylcyclotetrasiloxane with bisaminopropyltetra-methyldisiloxane is known, as described, for example, in U.S. Pat. No. 5,512,650. This reaction has the disadvantage that the reactant used is the expensive bisaminopropyltetramethyldisiloxane. In addition, the reaction times are long, and in the equilibration reaction are sometimes longer than 10 h.

A further process for preparing such polysiloxanes involves preparing them by cohydrolysing difunctional silanes with organofunctional aminosilanes. However, this has the disadvantage that, owing to the presence of amino groups, the cohydrolysis cannot be carried out using chlorosilanes, and alkoxysilanes have to be used instead. This means that the hydrolysis first has to be preceded by the esterification of the chlorosilanes which, in the subsequent hydrolysis, results in the valuable alcohol being lost.

DE-A-2500020 describes a process for preparing amino-methylsiloxanes. This involves reacting OH-terminated siloxanes with secondary aminomethylsilanes while eliminating alcohol. The advantage of this process is a reaction of a siloxane with an alkoxysilane without equilibrating the reaction mixture, which would lead to the by-production of cycles and is therefore not wanted. The disadvantage of this process is that, owing to the secondary amino function, the silicone oils prepared in this way cannot be used for preparing, for example, siloxane-polyimide copolymers, since a primary amino function is indispensable here.

It is therefore an object of the present invention to provide amino-functional siloxanes which may be used to prepare polysiloxane-polyimide copolymers, among other uses.

The present invention provides amino-functional organosiloxanes of the general formula I
[(HO)]R₂SiO_{1/2}]ₜ[R₃SiO_{1/2}][R₂SiO_{2/2}]ₚ[O_{1/2}SiR¹₂CR²₂NH₂]ₛ (I)
where
R is a hydrogen atom or a monovalent Si—C-bonded C₁-C₂₀-hydrocarbon radical or C₁-C₁₅-hydrocarbonoxy radical, each of which is optionally substituted by —CN, —NCO, —NR^{x}₂, —COOH, —COOR^{x}, -halogen, -acryl, -epoxy, —SH, —OH or —CONR^{X}₂, and in each of which one or more non-adjacent methylene units may be replaced by —O—, —CO—, —COO—, —OCO— or —OCOO—, —S— or —NR^{x}— groups, and in each of which one or more non-adjacent methine units may be replaced by —N═, —N═N— or —P═ groups,
R¹ is a hydrogen atom or a monovalent Si—C-bonded C₁-C₂₀-hydrocarbon radical which is optionally substituted by —CN, —NCO, —NR^{x}₂, —COOH, —COOR^{x}, -halogen, -acryl, -epoxy, —SH, —OH or —CONR^{x}₂ and in each of which one or more non-adjacent methylene units may be replaced by —O—, —CO—, —COO—, —OCO— or —OCOO—, —S— or —NR^{x}— groups, and in each of which one or more non-adjacent methine units may be replaced by —N═, —N═N— or —P═ groups,
R^{x} is a hydrogen or a C₁-C₁₀-hydrocarbon radical which is optionally substituted by —CN or halogen,
R² is a hydrogen or a C₁-C₂₀-hydrocarbon radical which is optionally substituted by -CN or halogen,
s is an integer of at least 1,
s+t+u has the value 2,
t and u each have the value 0 or 1 and
P has the value 0 or is an integer from 1 to 100,000.

The amino-functional organosiloxanes of the general formula I have a primary amino function which is bonded to a silicone atom of the siloxane chain via a carbon atom. The primary amino functions are very reactive. For example, polysiloxane-polyimide copolymers can therefore be easily prepared with the amino-functional siloxanes.

R may be aliphatically saturated or unsaturated, aromatic, straight-chain or branched. R is preferably an unbranched C₁-C₃-alkyl radical which may be substituted. R is more preferably a methyl radical.

The C₁-C₂₀-hydrocarbon radicals and C₁-C₂₀-hydrocarbonoxy radicals R¹ may be aliphatically saturated or unsaturated, aromatic, straight-chain or branched. R¹ preferably has 1 to 12 atoms, in particular 1 to 6 atoms, preferably only carbon atoms, or one alkoxy oxygen atom and otherwise only carbon atoms. R¹ is preferably a straight-chain or branched C-C₆-alkyl radical. Particular preference is given to the methyl, ethyl, phenyl, vinyl and trifluoropropyl radicals.

The R² radicals may each independently likewise be aliphatically saturated or unsaturated, aromatic, straight-chain or branched. R² is preferably a C₁-C₃-alkyl radical or hydrogen. R² is more preferably hydrogen.

The amino-functional organosiloxanes of the general formula I are preferably aminoalkyl-terminated polydimethylsiloxanes which bear an aminoalkyl group at at least 90% of the chain ends. In particular, the aminoalkyl-terminated polydimethylsiloxane bears an aminoalkyl group at at least 99% of the chain ends.

t preferably has the value 0.

p preferably has values of 4 to 500.

The invention likewise provides a process for preparing amino-functional organosiloxane of the general formula I, in which organosiloxane of the general formula II
[(HO)]R₂SiO_{1/2}]ᵥ[R₃SiO_{1/2}]ᵤ[R₂SiO_{2/2}]_{q}[H] (II)
is reacted with alkoxysilane of the general formula III
(R³O) R¹₂SiCR²₂NH₂ (III)
where
R³ is a C₁-C₁₅-hydrocarbon radical which is optionally cyano- or halogen-substituted,
q is an integer of at least 0,
v has the value 0 or 1,
u has the value 0 or 1,
v+u=1 and
R, R¹ and R² are each as defined above.

R³ may likewise be aliphatically saturated or unsaturated, aromatic, straight-chain or branched. R³ is preferably a C₁-C₃-alkyl radical. R³ is more preferably ethyl or methyl. R³ is most preferably a methyl radical.

The alkoxysilanes of the general formula III used may be prepared simply and in high yields by aminating the corresponding chloroalkyl(alkoxy)dialkylsilanes, for example under pressure in an ammonia atmosphere, as described in the patent SU 395371.

The alkoxysilanes prepared in this way react simply and very rapidly with hydroxy-functional silanes of the general formula II. The use of special catalysts can be dispensed with in this case.

In order to facilitate a reaction between the organosiloxane of the general formula II and the alkoxysilane of the general formula III, the organosiloxane of the general formula II has to contain hydroxyl groups. The reaction proceeds with elimination of the alcohol R³OH.

In the process for preparing amino-functional organosiloxane of the general formula I, the amount of the alkoxysilanes of the general formula III used is dependent upon the amount of the silanol groups to be functionalized. However, when the intention is to achieve complete functionalization of the OH groups, the alkoxysilane has to be added in at least equimolar amounts.

When the silanes of the general formula (III) are reacted with at least the equivalent amount of water, the hydrolysis product obtained is a disiloxane of the general formula (IV)
[O_{1/2}SiR¹₂CR²₂NH₂]₂ (IV)
where R¹ and R² are each as defined above.

Preference is given to carrying out the process at 0° C. to 100° C., more preferably at from at least 10° C. to at least 40° C. The process may be carried out either with the inclusion of solvents or else without the use of solvents, in suitable reactors. Operation is effected optionally under reduced pressure or under elevated pressure, or at atmospheric pressure (0.1 MPa). The alcohol formed may then be removed from the reaction mixture under reduced pressure at room temperature or at elevated temperature.

When solvents are used, preference is given to inert, in particular aprotic, solvents such as aliphatic hydrocarbons, for example heptane or decane, and aromatic hydrocarbons, for example toluene or xylene. Ethers such as THF, diethyl ether or MTBE may likewise be used. The amount of the solvent should be sufficient to ensure a sufficient homogenization of the reaction mixture. Solvents or solvent mixtures having a boiling point or boiling range of up to 120° C. at 0.1 MPa are preferred.

When the alkoxysilane of the general formula III is added to the organosiloxane of the general formula II in deficiency, remaining unreacted Si-OH groups may remain in the amino-functional organosiloxane of the general formula I or may react with other compounds which react with Si—OH groups, so that further reduction of the Si—OH content may be achieved and, for example, unreactive end groups may be introduced into the silicone oil mixture, which allows limiting of the molecular weight in later copolymerizations to be achieved. It is not necessarily essential to isolate the intermediate.

All of the symbols in the formulae above are each defined independently.

In the examples which follow, unless otherwise stated, all amounts and percentages are based on weights, all pressures are 0.10 MPa (abs.) and all temperatures are 20° C.

### COMPARATIVE EXAMPLE 1

In a 1 litre steel autoclave, 100 g of chloromethyl-dimethylmethoxysilane (Starfire Systems, Troy, USA) are reacted in an autoclave with 300 g of liquid ammonia at a temperature of 100° C. After 5 hours, the mixture was allowed to cool to room temperature, the autoclave was decompressed at atmospheric pressure and 500 ml of dry heptane were added. The precipitated ammonium chloride was filtered off, the heptane removed by distillation and the product purified by distillation. 56 g of aminomethyldimethylmethoxysilane were obtained.

### EXAMPLE 1

1000 g of bishydroxy-terminated polydimethylsiloxane having an average molecular weight of 3000 g/mol were reacted at room temperature with 79.2 g of (1-aminomethyl)dimethylmethoxysilane. ¹H NMR and ²⁹Si NMR showed that after 30 minutes, all OH groups had been converted to aminomethyl units and a bisaminomethyl-terminated polydimethylsiloxane had been obtained. The by-product methanol was removed under reduced pressure and 1050 g of bis(aminomethyl)polydimethylsiloxane were obtained.

### EXAMPLE 2

1000 g of bishydroxy-terminated polydimethylsiloxane having an average molecular weight of 3000 g/mol were reacted at room temperature with 83.2 g of (1-aminomethyl)dimethylmethoxysilane. ¹H NMR and ²⁹Si NMR showed that after 30 minutes, all OH groups had been converted to aminomethyl units. The residual silane was reacted by adding a few millilitres of water and the resulting bis(aminomethyl)tetramethyldisiloxane was removed under reduced pressure. This also distilled off the by-product methanol.

### EXAMPLE 3

100 g of bishydroxy-terminated polydimethylsiloxane having an average molecular weight of 13,000 g/mol were reacted at 50 C. with 1.85 g of aminomethyl-dimethylmethoxysilane. ¹H NMR and ²⁹Si NMR showed that after 1 hour, all OH groups had been converted to aminomethyl units.

### EXAMPLE 4

100 g of bishydroxy-terminated polydimethylsiloxane having an average molecular weight of 28,000 g/mol were reacted at 50° C. with 0.85 g of aminomethyl-dimethylmethoxysilane. ¹H NMR and ²⁹Si NMR showed that after 2 hours, all OH groups had been converted to aminomethyl units.

### EXAMPLE 5

100 g of bishydroxy-terminated polydiphenylsiloxane

having an average molecular weight of 1000 g/mol were reacted at 100° C. with 23.8 g of aminomethyl-dimethylmethoxysilane. ¹H NMR and ²⁹Si NMR showed that after 1 hour, all OH groups had been converted to aminomethyl units.

### EXAMPLE 6

1000 g of bishydroxy-terminated polymethylvinyl-co-polydimethylsiloxane having a vinyl:methyl ratio of 1:4 and an average molecular weight of 2500 g/mol were reacted at room temperature with 95.4 g of aminomethyl-dimethylmethoxysilane. ¹H NMR and ²⁹Si NMR showed that after 0.5 hour, all OH groups had been converted to aminomethyl units and no remaining aminomethyldimethyl-methoxysilane could be detected.

### EXAMPLE 7

100 g of bishydroxy-terminated polymethyl-trifluoro-propylsiloxane having a trifluoropropyl:methyl ratio of 1:1 and an average molecular weight of 900 g/mol were reacted at room temperature with 26.6 g of amino-methyldimethylmethoxysilane. ¹H NMR and ²⁹Si NMR showed that after 2 hours, all OH groups had been converted to aminomethyl units and no remaining aminomethyldimethyl-methoxysilane could be detected.

### EXAMPLE 8

1000 g of bishydroxy-terminated polydimethylsiloxane having an average molecular weight of 3000 g/mol were reacted at room temperature with 87.2 g of (1-aminomethyl)dimethylethoxysilane. ¹H NMR and ²⁹Si NMR showed that after 0.5 hour, all OH groups had been converted to aminomethyl units and a bisaminomethyl-terminated polydimethylsiloxane had been obtained. The by-product ethanol was removed under reduced pressure and 1050 g of bis(aminomethyl)polydimethylsiloxane were obtained.

### EXAMPLE 9

1000 g of bishydroxy-terminated polymethylvinylsiloxane having an average molecular weight of 3000 g/mol were reacted at room temperature with 71.2 g of (1-aminomethyl)dimethylmethoxysilane. ¹H NMR and ²⁹Si NMR showed that after 30 minutes, 90% of the OH groups had been converted to aminomethyl units and an aminomethyl-terminated polydimethylsiloxane had been obtained. The by-product methanol was removed under reduced pressure and 1050 g of aminomethyl-functional polydimethylsiloxane were obtained.

### EXAMPLE 10

215 g of bishydroxy-terminated polymethylvinylsiloxane having an average molecular weight of 860 g/mol were reacted at room temperature with 59.8 g of (1-aminomethyl)dimethylmethoxysilane. ¹H NMR and ²⁹Si NMR showed that after 30 minutes, all OH groups had been converted to aminomethyl units and a bisaminomethyl-terminated polydimethylsiloxane had been obtained. The by-product methanol was removed under reduced pressure and 1050 g of bis(aminomethyl)polydimethylsiloxane were obtained.

### EXAMPLE 11

119 g of (1-aminomethyl)dimethylmethoxysilane were dissolved in 200 ml of methanol and reacted with 10 g of distilled water. After stirring for 30 minutes, the solvent methanol was removed and the product distilled. 93 g (97% yield) of bis(aminomethyl)tetramethyldisiloxane were obtained.

### EXAMPLE 12

180 g of monohydroxy-terminated polydimethylsiloxane (prepared by anionic polymerization of C3 cycles) having an average molecular weight of 1800 g/mol were reacted at room temperature with 12.0 g of (1-aminomethyl) dimethylmethoxysilane. ¹H NMR and ²⁹Si NMR showed that after 30 minutes, all OH groups had been converted to aminomethyl units and a monoaminomethyl-terminated polydimethylsiloxane had been obtained. The by-product methanol was removed under reduced pressure and 190 g of aminomethylpolydimethylsiloxane were obtained.

1-8. (canceled)

9. An amino-functional organosiloxane of the formula I
[(HO)R₂SiO_{1/2}]ₜ[R₃SiO_{1/2}]ᵤ[R₂SiO_{2/2}]ₚ[O_{1/2}SiO¹₂NH₂]ₛ (I)
where
R is a hydrogen atom or a monovalent Si—C-bonded C₁-C₂₀-hydrocarbon radical or C₁-C₁₅-hydrocarbonoxy radical, each of which is optionally substituted by —CN, —NCO, —NR^{x}₂, —COOH, —COOR^{x}, -halogen, -acryl, -epoxy, —SH, —OH or —-CONR^{x}₂, and in each of which one or more non-adjacent methylene units are optionally replaced by —O—, —CO—, —COO—, —OCO—, —OCOO—, —S— or —NR^{x}— groups, and in each of which one or more non-adjacent methine units are optionally replaced by —N═, —N═N— or —P═ groups;
R¹ is a hydrogen atom or a monovalent Si—C-bonded, C₁-C₂₀-hydrocarbon radical which is optionally substituted by —CN, —NCO, —NR^{x}₂, —COOH, —COOR^{x}, -halogen, -acryl, -epoxy, —SH, —OH or —CONR^{x}₂, and in each of which one or more non-adjacent methylene units are optionally replaced by —O—, —CO—, —COO—, —OCO—, —OCOO—, —S— or —NR^{x}— groups, and in each of which one or more non-adjacent methine units are optionally replaced by —N═, —N═N— or —P═ groups;
R^{x} is a hydrogen or a C₁-C₁₀-hydrocarbon radical which is optionally substituted by —CN or halogen;
R² is a hydrogen or a C₁-C₂₀-hydrocarbon radical which is optionally substituted by —CN or halogen;
s is an integer greater than or equal to 1,
s+t+u is 2,
t and u are each 0 or 1, and
P is 0 or is an integer from 1 to 100,000.

10. The amino-functional organosiloxane of claim 9, in which R is an unbranched C₁-C₃-alkyl radical.

11. The amino-functional organosiloxane of claim 9, in which each R¹ independently is a radical selected from the group consisting of methyl, ethyl, phenyl, vinyl and trifluoropropyl radicals.

12. The amino-functional organosiloxane of claim 9, in which each R² independently is selected from the group consisting of C₁-C₃-alkyl radicals and hydrogen.

13. The amino-functional organosiloxane of claim 9, wherein aminoalkyl groups are present at at least 90% of the termini of said organosiloxanes.

14. A process for preparing amino-functional organosiloxanes of the formula I
[(HO)R₂SiO_{1/2}]ₜ[R₃SiO_{1/2}]ᵤ[R₂SiO_{2/2}]ₚ[O_{1/2}SiR¹₂CR²₂NH_{2 ]}ₛ (I)
comprising reacting at least one organosiloxane of the formula II
[(HO)R₂SiO_{1/2}]ᵥ[R₃SiO_{1/2}]ᵤ[R₂SiO_{2/2}]_{q}[H] (II)
with at least one alkoxysilane of the formula III
(R³O)R¹₂SiCR²₂NH₂ (III)
where
R is a hydrogen atom or a monovalent Si—C-bonded C₁-C₂₀-hydrocarbon radical or C₁-C₁₅-hydrocarbonoxy radical, each of which is optionally substituted by —CN, —NCO, —NR^{x}₂, —COOH, —COOR^{x}, -halogen, -acryl, -epoxy, —SH, —OH or —CONR^{x}₂, and in each of which one or more non-adjacent methylene units are optionally replaced by —O—, —CO—, —COO—, —OCO—, —OCOO—, —S— or —NR^{x}— groups, and in each of which one or more non-adjacent methine units are optionally replaced by —N═, —N═N— or —P═ groups;
R¹ is a hydrogen atom or a monovalent Si—C-bonded, C₁-C₂₀-hydrocarbon radical which is optionally substituted by —CN, —NCO, —NR^{x}₂, —COOH, —COOR^{x}, halogen, -acryl, -epoxy, —SH, —OH or —CONR^{x}₂, and in each of which one or more non-adjacent methylene units are optionally replaced by —O—, —CO—, —COO—, —OCO—, —OCOO—, —S— or —NR^{x}— groups, and in each of which one or more non-adjacent methine units are optionally replaced by —N═, —N═N— or —P═ groups;
R^{x} is a hydrogen or a C₁-C₁₅-hydrocarbon radical which is optionally substituted by —CN or halogen;
R² is a hydrogen or a C₁-C₂₀-hydrocarbon radical which is optionally substituted by —CN or halogen;
R³ is a C₁-C₁₅-hydrocarbon radical which is optionally substituted by —CN or halogen;
q is an integer equal to or greater than 0,
v is 0 or 1,
u is 0 or 1,
v+u=1, and
P is 0 or is an integer from 1 to 100,000.

15. The process of claim 14, in which R³ is a C₁-C₃-alkyl radical.

16. The process of claim 14, in which R is an unbranched C₁-C₃-alkyl radical.

17. The process of claim 14, in which each R¹ independently is a radical selected from the group consisting of methyl, ethyl, phenyl, vinyl and trifluoropropyl radicals.

18. The process of claim 14, in which each R² independently is selected from the group consisting of C₁-C₃-alkyl radicals and hydrogen.

19. The process of claim 14, wherein aminoalkyl groups are present at at least 90% of the termini of said organosiloxanes.

20. The process of claim 14, wherein a stoichiometric excess of alkoxysilane of the formula III is employed, and excess alkoxysilane is subsequently reacted with water to form a siloxane of the formula IV
[O_{1/2}SiR¹₂CR²₂NH₂]₂ (IV).

21. A process for reacting silanes of the formula (III)
(R³O)R^{l}₂SiCR²₂NH₂ (III)
with water to give siloxanes of the general formula (IV)
[O_{1/2}SiR¹₂CR²₂NH₂]₂ (IV),
where
R¹ is a hydrogen atom or a monovalent Si—C-bonded, C₁-C₂₀-hydrocarbon radical which is optionally substituted by —CN, —NCO, —NR^{x}₂, —COOH, —COOR^{x}, —halogen, -acryl, -epoxy, —SH, —OH or —CONR^{x}₂, and in each of which one or more non-adjacent methylene units are optionally replaced by —O—, —CO—, —COO—, —OCO—, —OCOO—, —S— or —NR^{x}— groups, and in each of which one or more non-adjacent methine units are optionally replaced by —N═, —N═N— or —P═ groups;
R² is a hydrogen or a C₁-C₂₀-hydrocarbon radical which is optionally substituted by —CN or halogen; and
R³ is a C₁-C₁₅-hydrocarbon radical which is optionally substituted by —CN or halogen.
